(19) United States
(12) Patent Application Publication
(10) Pub. No.: US 2013/0336140 A1
(43) Pub. Date: Dec. 19, 2013

(54) METHOD AND APPARATUS FOR DYNAMICALLY SWITCHING A CHANNEL

(71) Applicant: Huawei Technologies Co., Ltd., Shenzhen (CN)

(72) Inventor: Tao Ma, Shanghai (CN)

(21) Appl. No.: 13/906,024

(22) Filed: May 30, 2013

(30) Foreign Application Priority Data
Jun. 18, 2012 (CN) 201210201425.X

(51) Int. Cl. H04W 76/04

(52) U.S. Cl. CPC H04W 76/04
USPC 370/252; 370/336

(57) ABSTRACT

Embodiments of the present invention provide a method for dynamically switching a channel. The method in the embodiments of the present invention includes: detecting, on a current working channel, a signal strength of data sent by an interfering access point; determining whether the detected signal strength is greater than a switching threshold; detecting signal strengths of data sent by interfering access points in available channels, when the detected signal strength is greater than the switching threshold; and switching the current working channel to one of the available channels, where a signal strength of data sent by an interfering access point that is detected in the one of the available channels is at least lower than the switching threshold.

### CROSS-REFERENCE TO RELATED APPLICATION

This application claims priority to Chinese Patent Application No. 201210201425.X, filed on Jun. 18, 2012, which is hereby incorporated by reference in its entirety.

### TECHNICAL FIELD

The present invention relates to the field of communications technologies, and in particular, to a method and an apparatus for dynamically switching a channel.

### BACKGROUND

A wireless access point (AP, Access Point) is a wireless switching device used in a wireless network, is an access point for a mobile terminal user to enter a wired network, and is mainly used in broadband-equipped families, interiors of buildings and interiors of parks, with a coverage ranging from dozens of meters to thousands of meters. At present, the AP mainly supports WiFi technology standards, and its downlink may be connected to a WiFi station (STA, Station) to serve as an access device for a user to access a WAN, for example, a notebook computer of a user is connected to an AP of an operator as a STA; or, the AP is used as an access device for a user to access a LAN, for example, the AP accesses a network by connecting to an asymmetric digital subscriber line (ADSL, Asymmetric Digital Subscriber Line) through routing, or in other broadband connection manners.

Because the AP is a wireless device, it is easily affected by the environment, especially by interference of a wireless signal with the same property, such as interference of other AP devices with a current AP in a working condition. For reasons that the transmit power of the other AP devices is close to that of the current AP and so on, the current AP is greatly interfered, leading to low efficiency of receiving correct data, thereby greatly affecting the wireless network access experience of the user.

### SUMMARY

Embodiments of the present invention provide a method and an apparatus for dynamically switching a channel, which are capable of determining strengths of wireless interference signals with the same property and dynamically selecting a channel with less interference of the same property as a working channel, thereby improving transmission efficiency and providing a better wireless network access experience for a user.

An embodiment of the present invention provides a method for dynamically switching a channel. The method includes:

detecting, on a current working channel, a signal strength of data sent by an interfering access point;

determining whether the detected signal strength is greater than a switching threshold;

detecting signal strengths of data sent by interfering access points in available channels, when the detected signal strength is greater than the switching threshold; and

switching the current working channel to one of the available channels, where a signal strength of data sent by an interfering access point that is detected in the one of the available channels is at least lower than the switching threshold.

An embodiment of the present invention further provides an apparatus for dynamically switching a channel. The apparatus includes: a first detecting unit, a determining unit, a second detecting unit and a switching unit; where

the first detecting unit is configured to detect, on a current working channel, a signal strength of data sent by an interfering access point;

the determining unit is configured to determine whether the detected signal strength is greater than a switching threshold;

the second detecting unit is configured to detect signal strengths of data sent by interfering access points in available channels, when the detected signal strength is greater than the switching threshold; and

the switching unit is configured to switch the current working channel to one of the available channels, where a signal strength of data sent by an interfering access point that is detected in the one of the available channels is at least lower than the switching threshold.

An embodiment of the present invention further provides a method for dynamically switching a channel. The method includes:

releasing, by an access point in a chip, a current working channel;

establishing, by a station in the chip, connection with an uplink access point over a channel different from the current working channel;

selecting, by the access point in the chip, the channel over which the station establishes communication with the uplink access point as a new working channel; and

sharing, by the access point in the chip, the new working channel with the station in the chip in a time-division multiplexing manner.

An embodiment of the present invention further provides an apparatus for dynamically switching a channel. The apparatus includes a chip;

the chip includes: an access point module and a station module;

the access point module is configured to release a current working channel, select a channel over which the station module establishes communication with an uplink access point as a new working channel, and share the new working channel with the station module in the chip in a time-division multiplexing manner; and

the station module is configured to establish connection with the uplink access point over a channel different from the current working channel, and share the new working channel with the access point module in the chip in the time-division multiplexing manner.

From the foregoing technical solutions, it can be seen that, for the method provided by the embodiments of the present invention, the signal strength of the data sent by the interfering AP is detected on the current working channel, the signal strengths of the data sent by the interfering APs in the available channels are detected when the detected signal strength is greater than the switching threshold, and the channel with less interference is selected among the available channels as the new working channel, so that the AP has higher signal transmission efficiency, thereby providing a better wireless network access experience for a user.

### BRIEF DESCRIPTION OF DRAWINGS

To describe the technical solutions in the embodiments of the present invention or in the prior art more clearly, the following briefly introduces accompanying drawings required for describing the embodiments or the prior art. Apparently, the accompanying drawings in the following description show merely some embodiments of the present invention, and persons of ordinary skill in the art may still derive other drawings from the accompanying drawings without creative efforts.

FIG. 1 is a flowchart of a method for dynamically switching a channel according to Embodiment 1 of the present invention;

FIG. 2 is a flowchart of a method for dynamically switching a channel according to Embodiment 2 of the present invention;

FIG. 3 is a schematic diagram of an apparatus for dynamically switching a channel according to Embodiment 3 of the present invention;

FIG. 4 is a schematic diagram of an apparatus for dynamically switching a channel according to Embodiment 4 of the present invention;

FIG. 5 is a flowchart of a method for dynamically switching a channel according to Embodiment 5 of the present invention; and

FIG. 6 is a schematic diagram of an apparatus for dynamically switching a channel according to Embodiment 6 of the present invention.

### DESCRIPTION OF EMBODIMENTS

In view of a problem in the prior art that, after startup and selecting a working channel, an AP cannot select a better working channel as an environment changes, thereby causing that the AP suffers a reduction in efficiency of receiving/sending data over the working channel, the embodiments of the present invention provide a method for dynamically switching a channel, which is capable of efficiently overcoming the foregoing problem. The AP may select a channel, on which other APs have minimum interference in this AP, as the working channel according to received signal strengths of data packets sent by the other APs, and may intelligently change the working channel when channel quality reduces to a certain threshold, thereby providing a better network access service for a user. Reference can be made to the following embodiments for the detailed descriptions.

### Embodiment 1

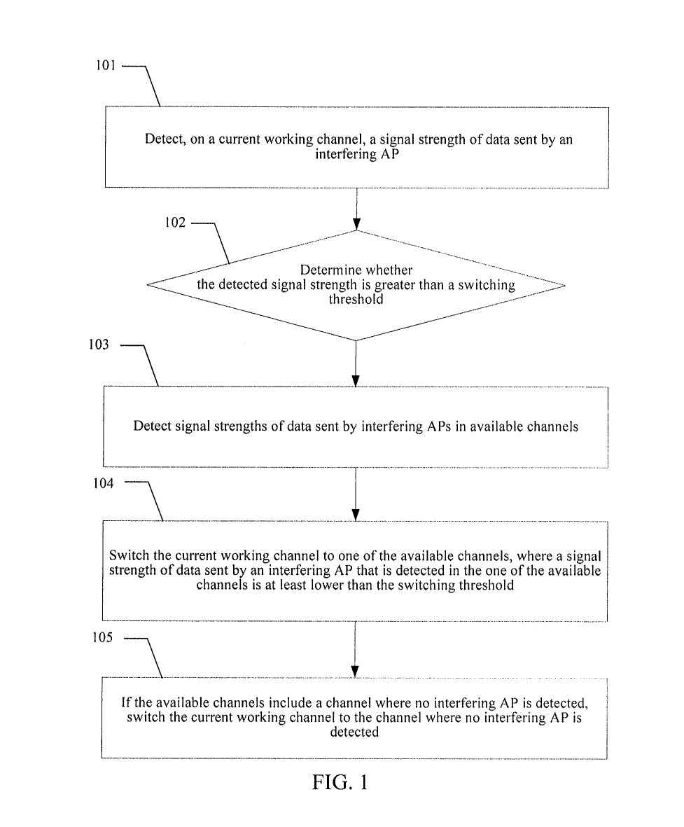

An embodiment of the present invention provides a method for dynamically switching a channel. As shown in FIG. 1, the method includes:

Step 101: Detect, on a current working channel, a signal strength of data sent by an interfering AP.

The AP mentioned in step 101 refers to an interfering AP for an AP executing step 101, and the signal strength of the data sent by the AP mentioned in step 101 causes interference in an AP working on the current channel. For convenience of understanding, the AP mentioned in step 101 may be referred to as “interfering AP” hereafter.

The AP executing the detection in step 101 is capable of receiving the data sent by the interfering AP, or data sent to the interfering AP. The data may be an unencrypted data packet, or a beacon (Beacon) frame sent by the interfering AP, or a probe response (Probe Response) sent by the interfering AP.

Step 102: Determine whether the detected signal strength is greater than a switching threshold, and if yes, execute step 103.

By executing step 102, the execution AP may determine that, on the current working channel, the strength of a signal sent by the interfering AP has severe interference in the working channel, and the execution AP needs to avoid the currently used working channel and select another channel with less interference as a working channel. If the signal strength detected in step 102 is lower than the switching threshold, it indicates that the environment of the current working channel is acceptable and communication quality can be guaranteed; therefore, the procedure may end without further processing.

It should also be noted that, in order to prevent the execution AP from switching the channel too frequently and to ensure that the execution AP can determine the channel environment more accurately, a specific execution process of step 102 may also include:

determining whether the detected signal strength of the interfering AP is greater than the switching threshold N times, and if yes, executing step 103;

or, determining whether an average value of signal strengths of the interfering AP in the N times of detection is greater than the switching threshold, and if yes, executing step 103.

It should be understood that, the switching threshold may be determined according to practical design requirements, and is not specifically limited by the embodiment of the present invention.

Step 103: Detect signal strengths of data sent by interfering APs in available channels, when the detected signal strength is greater than the switching threshold.

The available channels may be regarded as channels (Channel) which the execution AP may select and switch to. Corresponding to different areas, the Channels that the execution AP can use are different, for example, a channel set available in some areas is ranging from channel 1 to channel 13; a channel set supported by some areas is ranging from channel 1 to channel 14, such as Japan; a non-overlapping WiFi channel combination is recommended to be used in some areas, where the available channels are specifically channel 1, channel 6 and channel 11; and a non-overlapping WiFi channel combination is also recommended to be used in some areas, including channel 1, channel 5, channel 9 and channel 13. Therefore, when executing step 103, the execution AP needs to detect, on an optional channel other than the current working channel, the signal strength of the data sent by the interfering AP.

Assuming the current working channel of the execution AP is channel 6, taking WiFi channel combination rules of Japan as an example, current available channels specifically include: channel 1 to channel 5 and channel 7 to channel 14 except channel 6. The execution AP has 13 available channels. Alternatively, still assuming the current working channel of the execution AP is channel 6, taking overlapping channel 1, channel 6 and channel 11 in the WiFi channel combination rules as an example, the current available channels include: channel 1 and channel 11. The above are examples provided for easy understanding of the available channels, but these are not exhaustive; persons skilled in the art may easily derive corresponding available channels in different WiFi channel combinations according to the foregoing examples.

Step 104: Switch the current working channel to one of the available channels, where a signal strength of data sent by an interfering AP that is detected in the one of the available channels is at least lower than the switching threshold.

The working channel of the execution AP is switched to an available channel with less interference by executing step 104, so that the execution AP may avoid a channel with great signal interference. Therefore, the execution AP may select a better wireless channel environment, to ensure smoothness of communication. If interfering APs exist on all the available channels, but interference strengths of some channels are lower than the switching threshold, the working channel is switched to an available channel with minimum interference. If interference exists on all the available channels, and interference strengths of all the channels are greater than the switching threshold, the switching may not be started.

Through the description of the method for dynamically switching a channel provided by Embodiment 1 of the present invention, in the method, the signal strength of the data sent by the interfering AP on the current working channel is detected, the signal strengths of the data sent by the interfering APs in the available channels are detected when the detected signal strength is greater than the switching threshold, and the channel with less interference among the available channels is selected as the new working channel, so that the AP has higher signal transmission efficiency, thereby providing a better wireless network access experience for a user.

Further, the method may further include:

Step 105: If the available channels include a channel where no interfering AP is detected, switch the current working channel to the channel where no interfering AP is detected.

“If the available channels include the channel where no interfering AP is detected” mentioned in step 105 indicates that the channel environment of the available channel where no interfering AP is detected is good, and the interfering AP causes no interference in the execution AP; therefore, the working channel of the execution AP may be preferably switched to the available channel where no interfering AP is detected.

If the available channels include more than one channel where no interfering AP is detected, the execution AP may randomly select one of the channels as the working channel; if the random selection manner is not adopted, the execution AP may also select a channel according to a requirement of a designer, which shall not be construed as a limitation to the embodiment of the present invention herein.

### Embodiment 2

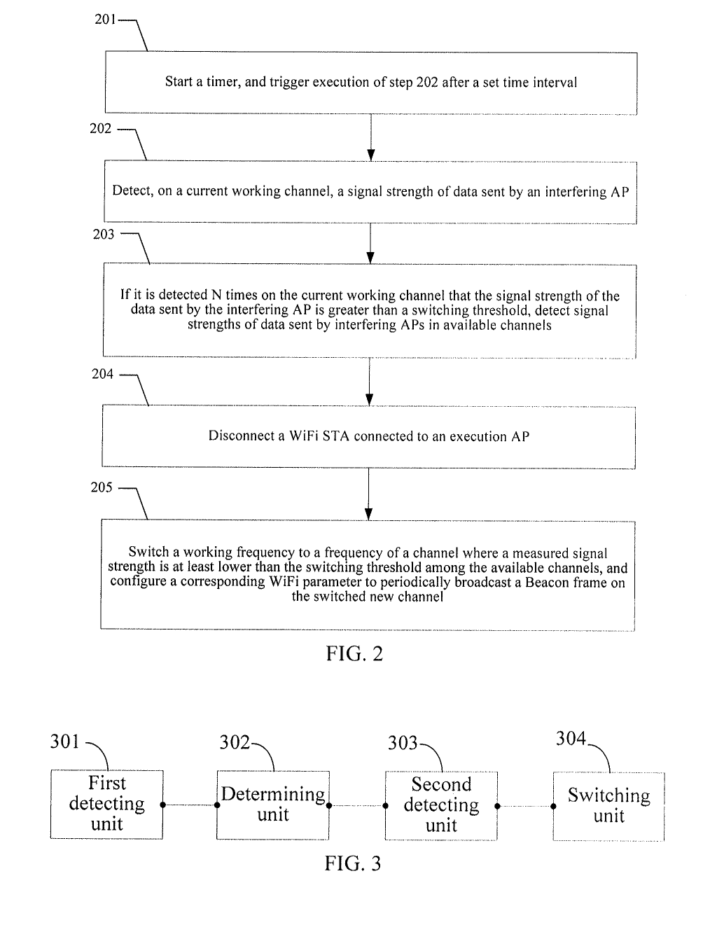

An embodiment of the present invention provides a method for dynamically switching a channel. The method is similar to the method provided in Embodiment 1, where the channel is switched to a channel with less interference when a detected signal strength is greater than a switching threshold. The difference lies in that, the method provided in Embodiment 2 is to provide a more improved and smarter channel switching solution on the basis of an inventive concept the same as that of Embodiment 1. Specifically, referring to FIG. 2, the method includes:

Step 201: Start a timer, and trigger execution of step 202 after a set time interval.

Step 202: Detect, on a current working channel, a signal strength of data sent by an interfering AP.

Data sent by an AP (no matter an execution AP or interfering AP) has three common types, but is not limited to the three types in the following examples:

One type is a data packet for data transmission, which may be unencrypted; therefore, a signal strength of the data packet may be detected after all APs on the same channel receive the data packet.

Another type is a data packet for passive interception, which may be specifically an AP Beacon frame. After accessing a certain channel, a WiFi STA receives data on the channel; and if finding a certain AP Beacon frame (broadcast packet), the WiFi STA performs demodulation and decoding processing. Then, according to received Beacon data, data such as a signal-to-noise ratio of the received Beacon data and a strength of a received signal may be calculated. In general, the AP sends out one Beacon broadcast packet every 100 ms (it is configurable or may be longer).

The last type is a data packet for active interception, which may be specifically a Probe Response sent by the AP. After accessing a certain channel, the WiFi STA sends out a Probe Request broadcast data packet actively; according to requirements of a WiFi protocol, all APs that receive this Probe Request should immediately feed back a Probe Response data packet, and inform the STA of related configuration information of the APs in the data packet. In this way, the WiFi STA may know whether there is an available AP on this channel, and may calculate data such as a signal-to-noise ratio of the received Probe Response data packet and a strength of a received signal according to the received Probe Response data packet. Compared with the passive interception, an advantage of the active interception is that the AP has a fast response speed.

Step 203: If it is detected N times on the current working channel that the signal strength of the data sent by the interfering AP is greater than the switching threshold, detect signal strengths of data sent by interfering APs in available channels, where N is an integer greater than zero.

If it is detected N times in step 203 that the signal strength of the data sent by the interfering AP is greater than the switching threshold, it indicates that the interfering AP has great interference in the current working channel and affects a communication service on the working channel. Therefore, an execution AP measures channels except the current working channel, to search for a channel environment with less interference. It should also be noted that, step 203 may have another alternative operation, for example, if it is detected N times on the current working channel that an average value of signal strengths of data sent by the interfering AP is greater than the switching threshold, detecting the signal strengths of the data sent by the interfering APs in the available channels. For persons skilled in the art, other alternative solutions that can be easily thought of are not illustrated one by one herein.

For a device in which the execution AP further includes a WiFi STA module, because interference exists between a working frequency of the execution AP and that of the WiFi STA, in order to reduce the interference between modules in the device having the execution AP module and the WiFi STA module, it is required that the working channel of the execution AP module remains consistent with that of the WiFi STA module (that is, the working channel of the execution AP module changes with that of the WiFi STA module). Taking the 13 channels standard in China as an example, assuming a current working channel of the WiFi STA module in the device is channel 6, a current working channel of the execution AP module is channel 1, and after the execution AP module executes step 201 to step 203, current available channels of the execution AP may specifically be channels except the working channel (channel 1) of the execution AP and the working channel(channel 6) of the WiFi STA, and are M channels far away from channel 6 and channel 1 (assuming that the value of M is 3). The current available channels of the execution AP module include: channel 2, channel 11, channel 12 and channel 13; after the execution AP module switches the channel, optional channels are the foregoing four channels. It should also be noted that, the channel standard, the value of M and a specific numerical value of the current working channel are examples given merely for easy understanding of the embodiment of the present invention, but shall not be construed as a limitation to the embodiment of the present invention.

Step 204: Disconnect a WiFi station connected to the execution AP.

Specifically, the execution AP actively sends a disconnection (Disassociate) message, to release the WiFi STA connected to the execution AP, and at the same time, releases the current working channel of the execution AP.

Step 205: Switch a working frequency to a frequency of a channel where a measured signal strength is at least lower than the switching threshold among the available channels, and configure a corresponding WiFi parameter to periodically broadcast a Beacon frame over the switched new channel.

Step 204 to step 205 show an implementation form of switching the current working channel to a channel on which the measured signal strength is the minimum among the available channels; and a designer may design a specific implementation method for switching a channel according to a specific protocol or standard, which shall not be construed as limitation to the present invention herein.

If the available channels include a channel where no interfering AP is detected, a signal strength in this channel may be considered to be the minimum, and the current working channel may be switched to this channel; and if multiple available channels where no interfering AP is detected exist, one of the channels may be randomly selected as a working channel.

If data sent by an interfering AP is detected on all the available channels, a channel on which a signal strength of the data sent by the interfering AP is the minimum is selected as the working channel. As a lower signal strength of the data sent by the interfering AP indicates less interference on this channel, by using this channel as the working channel of the execution AP, a wireless environment is improved and the communication quality is guaranteed.

If interference exist on all the available channels, but interference strengths of some channels are lower than the switching threshold, the working channel is switched to the channel with minimum interference; while if interference exist on all the available channels, and interference strengths of all the channels exceed the switching threshold, switching is not started. If on channel has multiple interfering APs, a interference value on this channel is a numerical value of signal energy of an AP with maximum interference.

Through step 201 to step 205, the execution AP successfully avoids a wireless channel with great interference and selects a channel with less interference as the working channel. For the WiFi STA connected to the execution AP, because the WiFi STA has an automatic reconnection function, after being disconnected from the execution AP in step 204, the STA attempts to search for an available AP on all Channels, and preferentially uses a recently connected AP to perform reconnection. In this way, after finding the last connected AP on another Channel, the AP will be connected preferentially.

Through the description of the method for dynamically switching a channel provided by Embodiment 2 of the present invention, in the method, the signal strength of the data sent by the interfering AP on the current working channel is detected, the signal strengths of the data sent by the interfering APs in the available channels are detected when the detected signal strength is greater than the switching threshold, and the channel with less interference among the available channels is selected as a new working channel, so that the AP has higher signal transmission efficiency, thereby providing a better wireless network access experience for a user.

### Embodiment 3

An embodiment of the present invention provides an apparatus for dynamically switching a channel. As shown in FIG. 3, the apparatus includes: a first detecting unit 301, a determining unit 302, a second detecting unit 303 and a switching unit 304.

The first detecting unit 301 is configured to detect, on a current working channel, a signal strength of data sent by an interfering AP.

The AP mentioned in the first detecting unit 301 refers to an interfering AP for the AP executing step 101, and the signal strength of the data sent by the AP mentioned in the first detecting unit 301 causes interference in an AP working on the current channel. For convenience of understanding, the AP in the first detecting unit 301 may be referred to as “interfering AP” hereafter.

The AP executing the detection is capable of receiving the data sent by the interfering AP, or data sent to the interfering AP. The data may be an unencrypted data packet, or a beacon (Beacon) frame sent by the interfering AP, or a probe response (Probe Response) sent by the interfering AP.

The determining unit 302 is configured to determine whether the detected signal strength is greater than a switching threshold.

Through the determining unit 302, the execution AP may determine that, on the current working channel, the strength of a signal sent by the interfering AP has severe interference in the working channel, and the execution AP needs to avoid the currently used working channel and select another channel with less interference as a working channel. If the determining unit 302 determines that the detected signal strength is lower than the switching threshold, it indicates that the environment of the current working channel is acceptable and communication quality is guaranteed; therefore, the procedure may end without further processing.

The second detecting unit 303 is configured to detect signal strengths of data sent by interfering APs in available channels, when the detected signal strength is greater than the switching threshold.

The available channels may be regarded as channels (Channel) which the execution AP may select and switch to. Corresponding to different areas, Channels that the execution AP can use are different, for example, a available channel set in some areas is ranging from channel 1 to channel 13; a channel set supported by some areas is ranging from channel 1 to channel 14, such as Japan; a non-overlapping WiFi channel combination is recommended to be used in some areas, where the available channels are specifically channel 1, channel 6 and channel 11; and a non-overlapping WiFi channel combination is also recommended to be used in some areas, including channel 1, channel 5, channel 9 and channel 13. Therefore, the second detecting unit 303 needs to detect, on an optional channel other than the current working channel, the signal strength of the data sent by the interfering AP.

Assuming the current working channel of the execution AP is channel 6, taking WiFi channel combination rules of Japan as an example, current available channels specifically include: channel 1 to channel 5 and channel 7 to channel 14 except channel 6. The execution AP has 13 available channels. Alternatively, still assuming the current working channel of the execution AP is channel 6, taking overlapping channel 1, channel 6 and channel 11 in the WiFi channel combination rules as an example, the current available channels include: channel 1 and channel 11. The above are examples provided for easy understanding of the available channels, but these are not exhaustive; persons skilled in the art may easily derive corresponding available channels in different WiFi channel combinations according to the foregoing examples.

The switching unit 304 switches the current working channel to one of the available channels, where a signal strength of data sent by an interfering AP that is detected in the one of the available channels is at least lower than the switching threshold.

The switching unit 304 switches the working channel of the execution AP to an available channel with less interference, so that the execution AP may avoid a channel with great signal interference. Therefore, the execution AP may select a better wireless channel environment, to ensure smoothness of communication.

Through the description of the apparatus for dynamically switching a channel provided by Embodiment 3 of the present invention, in the apparatus, the first detecting unit detects the signal strength of the data sent by the interfering AP on the current working channel, the second detecting unit detects the signal strengths of the data sent by the interfering APs in the available channels when the detected signal strength is greater than the switching threshold, and the switching unit selects the channel with less interference among the available channels as a new working channel, so that the AP has higher signal transmission efficiency, thereby providing a better wireless network access experience for a user.

Further, the switching unit 304 may also specifically be configured to, if the available channels include a channel where no interfering AP is detected, switch the current working channel to the channel where no interfering AP is detected.

“If the available channels include the channel where no interfering AP is detected” mentioned in the switching unit 304 indicates that the channel environment of the available channel where no interfering AP is detected is good, and the interfering AP causes no interference in the execution AP; therefore, the working channel of the execution AP may be preferably switched to the available channel where no interfering AP is detected.

If the available channels include more than one channel where no interfering AP is detected, the execution AP may randomly select one of the channels as the working channel; if the random selection manner is not adopted, the execution AP may also select a channel according to a requirement of a designer, which shall not be construed as a limitation to the embodiment of the present invention herein.

### Embodiment 4

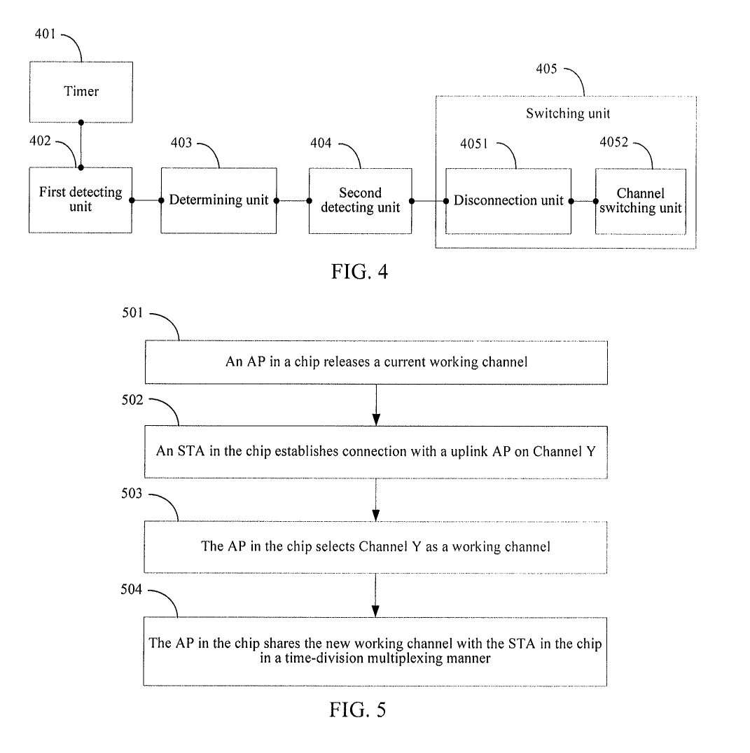

An embodiment of the present invention provides an apparatus for dynamically switching a channel. The apparatus is similar to the apparatus provided in Embodiment 3, where the channel is switched to a channel with less interference when the detected signal strength is greater than the switching threshold. The difference lies in that, the apparatus provided in Embodiment 4 is to provide a more improved and smarter channel switching solution on the basis of an inventive concept the same as that of Embodiment 3. Specifically, referring to FIG. 4, the apparatus includes: a timer 401, a first detecting unit 402, a determining unit 403, a second detecting unit 404 and a switching unit 405.

The timer 401 is configured to notify the first detecting unit 402 after a set time interval.

The first detecting unit 402 is configured to detect, on a current working channel, a signal strength of data sent by an interfering AP.

The determining unit 403 is configured to determine whether the detected signal strength is greater than a switching threshold.

The second detecting unit 404 is specifically configured to, if it is detected N times on the current working channel that the signal strength of the data sent by the interfering AP is greater than the switching threshold, detect signal strengths of data sent by interfering APs in available channels.

If the determining unit 403 determines that it is detected N times that the signal strength of the data sent by the interfering AP is greater than the switching threshold, it indicates that the interfering AP has great interference in the current working channel and affects a communication service on the working channel. Therefore, an execution AP measures channels except the current working channel, to search for a channel environment with less interference.

For a device in which the execution AP further includes a WiFi STA module, because interference exists between a working frequency of the execution AP and that of the WiFi STA, in order to reduce interference between modules in the device having an execution AP module and the WiFi STA module. Taking the 13 channels standard in China as an example, assuming a current working channel of the WiFi STA module in the device is channel 6, a current working channel of the execution AP module is Channel 1, and after the execution AP module executes step 201 to step 203, current available channels of the execution AP may specifically be channels except the working channel (channel 1) of the execution AP and the working channel(channel 6) of the WiFi STA, and are M channels far away from channel 6 and channel 1(assuming that the value of M is 3). The current available channels of the execution AP module include: channel 2, channel 11, channel 12 and channel 13; after the execution AP module switches the channel, the optional channels are the foregoing four channels. It should also be noted that, the channel standard, the value of M and a specific numerical value of the current working channel are examples given merely for easy understanding of the embodiment of the present invention, but shall not be construed as a limitation to the embodiment of the present invention.

The switching unit 405 may specifically include: a disconnection unit 4051 and a channel switching unit 4052.

The disconnection unit 4051 is configured to disconnect a WiFi STA connected to the execution AP.

Specifically, the disconnection unit 4051 actively sends a disconnection (Disassociate) message, to release the WiFi STA connected to the execution AP, and at the same time, releases the current working channel of the execution AP.

The channel switching unit 4052 is configured to switch a working frequency to a frequency of a channel where a measured signal strength is the minimum among the available channels, and configure a corresponding WiFi parameter, to periodically broadcast a Beacon frame over the switched new channel.

If the available channels include a channel where no interfering AP is detected, the signal strength in this channel may be considered to be the minimum, and the current working channel may be switched to this channel; and if multiple available channels where no interfering AP is detected exist, one of the channels may be randomly selected as a working channel.

If data sent by an interfering AP is detected on all the available channels, a channel on which a signal strength of the data sent by the interfering AP is the minimum is selected as the working channel. As a lower signal strength of the data sent by the interfering AP indicates less interference on this channel, by using this channel as the working channel of the execution AP, a wireless environment is improved and the communication quality is guaranteed.

The disconnection unit 4051 and the channel switching unit 4052 enable the execution AP to successfully avoid a wireless channel with great interference and select a channel with less interference as the working channel. For the WiFi STA connected to the execution AP, because the WiFi STA has an automatic reconnection function, after being disconnected from the execution AP in step 204, the STA attempts to reconnect to the original execution AP, and if finding the original execution AP again, the STA establishes connection with the original execution AP according to a channel reallocated by the original execution AP (this channel is a channel to which the execution AP switches).

Through the description of the apparatus for dynamically switching a channel provided by Embodiment 4 of the present invention, in the apparatus, the first detecting unit detects the signal strength of the data sent by the interfering AP on the current working channel, the second detecting unit detects the signal strengths of the data sent by the interfering APs in the available channels when the detected signal strength is greater than the switching threshold, and the switching unit selects the channel with less interference among the available channels as a new working channel, so that the AP has higher signal transmission efficiency, thereby providing a better wireless network access experience for a user.

For the detailed descriptions of the apparatuses illustrated in Embodiment 3 and Embodiment 4, reference may also be made to the methods illustrated in Embodiment 1 and Embodiment 2.

### Embodiment 5

For a single chip working scenario supporting WiFi Offload, an AP and a STA are integrated in one WiFi chip; the AP and the STA work under the same channel in a time-division multiplexing manner. If the WiFi chip merely enables an AP function while an STA function is still in a disabled state, or the STA is enabled but not connected to an uplink AP and a working channel of the AP is channel X (Channel X); and then, the STA function is enabled, and a channel to be allocated to the STA by an uplink AP connected to the STA is channel Y (Channel Y). In order to ensure that both the AP and the STA in the chip can work normally, the AP in the chip is disconnected from Channel X, the STA in the chip establishes connection with the uplink AP on Channel Y, and the AP in the chip uses Channel Y as the working channel and sends a Beacon frame over this channel. The above is one of scenarios of examples provided for easy understanding of the embodiment of the present invention, but these are not exhaustive. It should also be understood that, the embodiment of the present invention is not limited to the scenario where the single chip includes the AP and the STA; and a case that the AP and the STA share the same working channel in the time-division multiplexing manner under a condition of multiple chips still belongs to a concept the same as that of the embodiment of the present invention.

In a case that a working channel of the STA in the single chip is inconsistent with the working channel of the AP in the chip, the embodiment of the present invention provides a method for switching a channel. As shown in FIG. 5, the method includes:

Step 501: The AP in the chip releases a current working channel, where it is assumed that the current working channel is Channel X.

Step 502: The STA in the chip establishes connection with the uplink AP on Channel Y, where channel Y and channel X are not the same channel.

The uplink AP and the AP in the chip need to be distinguished. The uplink AP is an AP which is independent of the chip, that is, an external device, and at an upper layer of the STA in a network; an unlink of the STA needs to be connected to an external AP, and according to an existing protocol, the working channel used by the STA is allocated by the uplink AP. Therefore, Channel Y in step 502 is allocated by the uplink AP.

According to the existing protocol, a specific operation that the STA in the chip establishes connection with the uplink AP may include:

Step 5021: The STA interacts with the uplink AP, to acquire information of the uplink AP.

A specific operation of step 5021 may be using a probe request/probe response (Probe request/Probe response, or Proactive for short) to acquire information of an available uplink AP. For an operation process, reference may specifically be made to the prior art.

Step 5022: The STA performs authentication and identity verification with the uplink AP, where reference may specifically be made to a protocol in the prior art for a specific process, which is not described in detail herein.

Step 5023: The STA associates with the uplink AP according to a result of the authentication and verification in step 5022, to obtain full access rights to the network.

Through step 5021 to step 5023, the connection between the STA in the chip and the uplink AP may be established. For detailed description of this process, reference may be made to the prior art.

Step 503: The AP in the chip selects Channel Y as a working channel.

In the chip including the AP and the STA, Wifi-offload (Wifi-offload) may be specifically controlled by software, so that the STA in the chip searches for an available uplink AP, thereby knowing channel Y used by the STA in the chip, and the AP in the chip may know the working channel of the STA. In addition, time required to execute step 501 to step 503 may be set to T6, the specific value of which may be determined by a designer,

Step 504: The AP in the chip shares the new working channel with the STA in the chip in the time-division multiplexing manner.

A specific operation of step 504 may include:

Step 5041: Receive data sent by the uplink AP or by an external STA.

Step 5042: If the data sent by the external STA is received, send the data in a data format of the AP in the chip in the time-division multiplexing manner.

Step 5043: If the data sent by the uplink AP is received, send the data in a data format of the STA in the chip in the time-division multiplexing manner.

The chip includes both an AP function and a STA function. When receiving data, because of being on the same channel Y, the chip is capable of receiving all data from both the uplink AP and the external STA; when sending data individually, if the data received from the upper layer is that of the AP, the data is sent in the format of the AP in the time-division multiplexing manner, and if it is the data of the STA, the data is sent in the format of the STA in the time-division multiplexing manner.

That the STA in the chip shares the new working channel in the time-division multiplexing manner in step 504 may specifically include:

the STA in the chip occupies Channel Y to communicate with the uplink AP, to acquire an IP address used on the Internet; and the STA in the chip communicates with the uplink AP according to the acquired IP address in the time-division multiplexing manner.

The operation that the STA in the chip occupies Channel Y to communicate with the uplink AP to acquire an IP address used on the Internet may specifically include: the STA in the chip occupies Channel Y to communicate with the uplink AP; and the STA performs extensible authentication protocol combined with the subscriber identity module (EAP-SIM, Extensible Authentication Protocol combined with the Subscriber Identity Module) authentication, to acquire the IP used on the Internet. However, the specific implementation and operation of step 504 are not limited herein, and shall not be construed as a limitation to the embodiment of the present invention.

It should be understood that, the STA obtains, from a WAN port, an IP can be used on the Internet, so as to provide a data forwarding function for an internal LAN; an IP of the internal LAN is an internal address which cannot be used on the Internet, so that data forwarding needs to be performed.

Through step 501 to step 504, the function of integrating the AP and the STA on a single chip is implemented, the integrated AP and STA may work under the same channel, and the AP in the chip may dynamically switch the working channel of the AP in the chip according to the working channel of the STA in the chip.

Further, after step 502 and before step 503, the method may further include:

Step 505: Determine whether Channel Y and Channel X are the same channel, if yes, no need to execute the operation of disconnecting the current working channel in step 501; while if not, further execute step 503.

### Embodiment 6

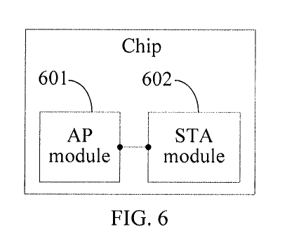

An embodiment of the present invention provides an apparatus for dynamically switching a channel. As shown in FIG. 6, the apparatus includes a chip; and the chip includes: an AP module 601 and a STA module 602.

The AP module 601 is configured to release a current working channel, select a channel over which the STA module establishes communication with an uplink AP as a new working channel, and share the new working channel with the STA module in the chip in a time-division multiplexing manner.

The STA module 602 is configured to establish connection with the uplink AP over a channel different from the current working channel, and share the new working channel with the AP module in the chip in the time-division multiplexing manner.

Further, that the STA module is configured to establish connection with the uplink AP over the channel different from the current working channel specifically includes:

the STA module is configured to interact with the uplink AP, to acquire information of the uplink AP;

the STA module is configured to perform authentication and identity verification with the uplink AP; and

the STA module is configured to associate with the uplink AP according to a result of the authentication and identity verification, to obtain full access rights to a network.

Further, that the AP module shares the new working channel with the STA module in the time-division multiplexing manner specifically includes:

the STA module receives data sent by the uplink AP, or the AP module receives data sent by an external STA;

if the data sent by the external STA is received, the AP module is configured to send the data in a data format of the AP in the chip in the time-division multiplexing manner; and

if the data sent by the uplink AP is received, the STA module is configured to send the data in a data format of the STA in the chip in the time-division multiplexing manner.

Further, that the STA module is configured to share the new working channel in the time-division multiplexing manner specifically includes:

the STA module is configured to, when occupying the new working channel, acquire an Internet protocol address used on the Internet; and

the STA module is configured to communicate with the uplink AP according to the Internet Protocol address in the time-division multiplexing manner.

For understanding of the apparatus, reference may be made to the description about the method in Embodiment 5, which is not described again herein.

Persons of ordinary skill in the art may understand that all or a part of the steps of the method in the embodiments may be implemented by a program instructing relevant hardware. The program may be stored in a computer readable storage medium. The storage medium may be a read-only memory, a magnetic disk, an optical disk or the like.

The above introduces in detail a method and an apparatus for dynamically switching a channel provided by the present invention. For persons of ordinary skill in the art, according to the concepts of the embodiments of the present invention, changes can be made to both the specific implementation manners and the application scope. To sum up, the content of the specification shall not be construed as a limitation to the present invention.

What is claimed is:

1. A method for dynamically switching a channel, comprising:
Detecting, on a current working channel, a signal strength of data sent by an interfering access point;
determining whether the detected signal strength is greater than a switching threshold;
detecting signal strengths of data sent by interfering access points in available channels, when the detected signal strength is greater than the switching threshold; and
switching the current working channel to one of the available channels, wherein a signal strength of data sent by an interfering access point that is detected in the one of the available channels is at least lower than the switching threshold.

2. The method according to claim 1, wherein the switching the current working channel to one of the available channels comprises:
if the available channels comprise a channel where no interfering access point is detected, switching the current working channel to the channel where no interfering access point is detected.

3. The method according to claim 2, wherein if the available channels comprise more than one channel where no interfering access point is detected, randomly switching the current working channel to one of channels where no interfering access point is detected.

4. The method according to claim 1, further comprising:
starting a timer, and after a set time interval, triggering execution of the detecting, on the current working channel, the signal strength of the data sent by the interfering access point, wherein
the detecting the signal strengths of the data sent by the interfering access points in the available channels, when the detected signal strength is greater than the switching threshold specifically comprises:
when it is detected N times on the current working channel that the signal strength of the data sent by the interfering access point is greater than the switching threshold, detecting the signal strengths of the data sent by the interfering access points in the available channels, wherein N is an integer greater than zero.

5. The method according to claim 1, wherein the switching the current working channel to one of the available channels comprises:
disconnecting a WiFi station connected to an execution access point; and
switching a working frequency to a frequency of a channel where a measured signal strength is at least lower than the switching threshold among the available channels, and configuring a corresponding WiFi parameter, to periodically broadcast a Beacon frame over the switched new channel.

6. An apparatus for dynamically switching a channel, comprising: a first detecting unit, a determining unit, a second detecting unit and a switching unit, wherein
the first detecting unit is configured to detect, on a current working channel, a signal strength of data sent by an interfering access point;
the determining unit is configured to determine whether the detected signal strength is greater than a switching threshold;
the second detecting unit is configured to detect signal strengths of data sent by interfering access points in available channels, when the detected signal strength is greater than the switching threshold; and
the switching unit is configured to switch the current working channel to one of the available channels, wherein a signal strength of data sent by an interfering access point that is detected in the one of the available channels is at least lower than the switching threshold.

7. The apparatus according to claim 6, wherein
the switching unit is further configured to, if the available channels comprise a channel where no interfering access point is detected, switch the current working channel to the channel where no interfering access point is detected.

8. The apparatus according to claim 7, wherein the switching unit is specifically configured to, if the available channels comprise more than one channel where no interfering access point is detected, randomly switch the current working channel to one of channels where no interfering access point is detected.

9. The apparatus according to claim 6, further comprising:
a timer, configured to, after a set time interval, trigger execution of the detecting, on the current working channel, the signal strength of the data sent by the interfering access point, wherein
the second detecting unit is configured to, when it is detected N times on the current working channel that the signal strength of the data sent by the interfering access point is greater than the switching threshold, detect the signal strengths of the data sent by the interfering access points in the available channels, wherein N is an integer greater than zero.

10. The apparatus according to claim 6, wherein the switching unit comprises: a disconnection unit and a channel switching unit,
the disconnection unit is configured to disconnect a WiFi station connected to an execution access point; and
the channel switching unit is configured to switch a working frequency to a frequency of a channel where a measured signal strength is at least lower than the switching threshold among the available channels, and configure a corresponding WiFi parameter, to periodically broadcast a Beacon frame over the switched new channel.

11. A method for dynamically switching a channel, comprising:
releasing, by an access point in a chip, a current working channel;
establishing, by a station in the chip, connection with an uplink access point over a channel different from the current working channel;
selecting, by the access point in the chip, the channel over which the station establishes communication with the uplink access point as a new working channel; and
sharing, by the access point in the chip, the new working channel with the station in the chip in a time-division multiplexing manner.

12. The method according to claim 11, wherein the establishing, by the station in the chip, connection with the uplink access point over the channel different from the current working channel comprises:
interacting, by the station, with the uplink access point, to acquire information of the uplink access point;
performing, by the station, authentication and identity verification with the uplink access point; and
associating, by the station, with the uplink access point according to a result of the authentication and identity verification, to obtain full access rights to a network.

13. The method according to claim 11, wherein the sharing, by the access point in the chip, the new working channel with the station in the chip in the time-division multiplexing manner comprises:
receiving data sent by the uplink access point or an external station;
if the data sent by the external station is received, sending the data in a data format of the access point in the chip in the time-division multiplexing manner; and
if the data sent by the uplink access point is received, sending the data in a data format of the station in the chip in the time-division multiplexing manner.

14. The method according to claim 11, wherein the sharing, by the station in the chip, the new working channel in the time-division multiplexing manner comprises:
when the station occupies the new working channel, acquiring an Internet protocol address used on the Internet; and
communicating, by the station, with the uplink access point according to the Internet protocol address in the time-division multiplexing manner.

15. An apparatus for dynamically switching a channel, comprising: a chip, wherein
the chip comprises: an access point module and a station module;
the access point module is configured to release a current working channel, select a channel over which the station module establishes communication with an uplink access point as a new working channel, and share the new working channel with the station module in the chip in a time-division multiplexing manner; and
the station module is configured to establish connection with the uplink access point over a channel different from the current working channel, and share the new working channel with the access point module in the chip in the time-division multiplexing manner.

16. The apparatus according to claim 15, wherein that the station module is configured to establish connection with the uplink access point over the channel different from the current working channel comprises:
the station module is configured to interact with the uplink access point, to acquire information about the uplink access point;
the station module is configured to perform authentication and identity verification with the uplink access point; and
the station module is configured to associate with the uplink access point according to a result of the authentication and identity verification, to obtain full access rights to a network.

17. The apparatus according to claim 15, wherein that the access point module shares the new working channel with the station module in the time-division multiplexing manner comprises:
receiving, by the station module, data sent by the uplink access point, or receiving, by the access point module, data sent by an external station, wherein
if the data sent by the external station is received, the access point module is configured to send the data in a data format of the access point in the chip in the time-division multiplexing manner; and
if the data sent by the uplink access point is received, the station module is configured to send the data in a data format of the station in the chip in the time-division multiplexing manner.

18. The apparatus according to claim 15, wherein that the station module is configured to share the new working channel in the time-division multiplexing manner comprises:
the station module is configured to, when occupying the new working channel, acquire an Internet protocol address used on the Internet; and
the station module is configured to communicate with the uplink access point according to the Internet protocol address in the time-division multiplexing manner.
